(19) United States
(12) Patent Application Publication
(10) Pub. No.: US 2023/0053887 A1
(43) Pub. Date: Feb. 23, 2023

(54) PLASMA SOURCE AND SWITCH DEVICE

(71) Applicants: KABUSHIKI KAISHA TOSHIBA, Tokyo (JP); TOSHIBA ENERGY SYSTEMS & SOLUTIONS CORPORATION, Kawasaki-shi Kanagawa (JP)

(72) Inventors: Hisao MIYAZAKI, Yokohama Kanagawa (JP); Hisashi YOSHIDA, Kawasaki Kanagawa (JP); Shigeya KIMURA, Yokohama Kanagawa (JP); Toshiaki MATSUMOTO, Kokubunji Tokyo (JP); Takaaki MURATA, Kawasaki Kanagawa (JP); Ryota SUGANUMA, Inagi Tokyo (JP)

(73) Assignees: KABUSHIKI KAISHA TOSHIBA, Tokyo (JP); TOSHIBA ENERGY SYSTEMS & SOLUTIONS CORPORATION, Kawasaki-shi Kanagawa (JP)

(21) Appl. No.: 17/864,866

(22) Filed: Jul. 14, 2022

(30) Foreign Application Priority Data
Aug. 17, 2021 (JP) 2021-132586

(51) Int. Cl. H01J 17/06

(52) U.S. Cl. CPC H01J 17/06; H01J 17/16

(57) ABSTRACT

According to one embodiment, a plasma source includes a container being configured to store a gas, a cathode member, and an anode member. The cathode member is provided in the container. The cathode member includes a plurality of first cathode layers. Each the cathode layers are arranged along a plurality of sides of a polygon. Each of the first cathode layers includes a first surface facing inside the polygon. The first surface is planar. The anode member is provided in the container.

### CROSS-REFERENCE TO RELATED APPLICATIONS

This application is based upon and claims the benefit of priority from Japanese Patent Application No. 2021-132586, filed on Aug. 17, 2021; the entire contents of which are incorporated herein by reference.

### FIELD

Embodiments described herein generally relate to a plasma source and a switch device.

### BACKGROUND

For example, there is a switch using plasma. High-density plasma is desired in the plasma source.

### BRIEF DESCRIPTION OF THE DRAWINGS

FIGS. 1A and 1B are schematic cross-sectional views illustrating a plasma source according to a first embodiment;

FIG. 2 is a schematic view illustrating an operation of the plasma source according to the first embodiment;

FIG. 3 is a schematic cross-sectional view illustrating a part of the plasma source according to the first embodiment;

FIGS. 4A to 4C are graphs illustrating the characteristics of the plasma source according to the first embodiment;

FIGS. 5A and 5B are graphs illustrating the characteristics of the plasma source according to the first embodiment;

FIGS. 6A and 6B are graphs illustrating the characteristics of the plasma source according to the first embodiment;

FIG. 7 is a graph illustrating the characteristics of the plasma source according to the first embodiment;

FIGS. 8A to 8C are electron micrographs illustrating a part of the plasma source according to the first embodiment;

FIGS. 9A to 9C are schematic views illustrating a part of the plasma source according to the first embodiment;

FIG. 10 is a graph illustrating the characteristics of the plasma source according to the first embodiment;

FIG. 11 is a schematic cross-sectional view illustrating a plasma source according to the first embodiment;

FIG. 12 is a schematic cross-sectional view illustrating a part of a plasma source according to the first embodiment;

FIGS. 13A and 13B are schematic cross-sectional views illustrating a part of a plasma source according to a second embodiment; and

FIG. 14 is a schematic cross-sectional view illustrating a switch device according to a third embodiment.

### DETAILED DESCRIPTION

According to one embodiment, a plasma source includes a container being configured to store a gas, a cathode member, and an anode member. The cathode member is provided in the container. The cathode member includes a plurality of first cathode layers. Each the cathode layers are arranged along a plurality of sides of a polygon. Each of the first cathode layers includes a first surface facing inside the polygon. The first surface is planar. The anode member is provided in the container.

According to one embodiment, a plasma source includes a container being configured to store a gas, a cathode member, and an anode member. The cathode member is provided in the container. The cathode member includes a plurality of stacked bodies. Each of the stacked bodies includes a first cathode layer, a second cathode layer, and a first substrate provided between the first cathode layer and the second cathode layer. The stacked bodies are arranged along a plurality of sides of the polygon. A first surface of the first cathode layer and a second surface of the second cathode layer are planar. The anode member is provided in the container.

According to one embodiment, a switch device includes the plasma source according to any one of the above, and a control conductive part provided in the container.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

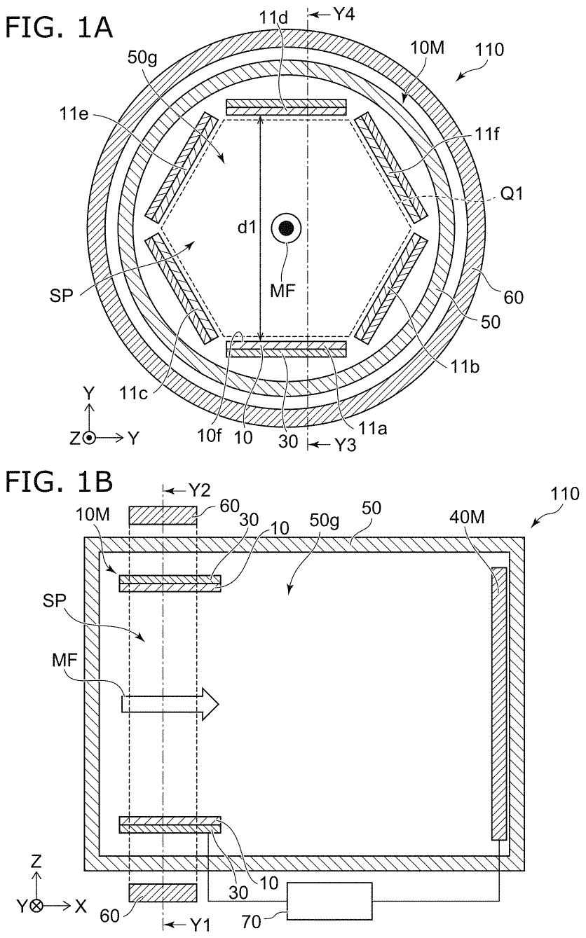

FIGS. 1A and 1B are schematic cross-sectional views illustrating a plasma source according to a first embodiment.

FIG. 1A is a cross-sectional view taken along the line Y1-Y2 of FIG. 1B. FIG. 1B is a cross-sectional view taken along the line Y3-Y4 of FIG. 1A.

As shown in FIGS. 1A and 1B, a plasma source 110 according to the embodiment includes a container 50, a cathode member 10M, and an anode member 40M.

The container 50 can store gas 50g. The gas 50g is stored in the space inside the container 50. The gas 50g includes, for example, at least one selected from the group consisting of argon, helium, hydrogen, and deuterium. The plasma source 110 may include gas 50g. When using the plasma source 110, gas 50g may be introduced into the container 50. For example, the gas 50g may be introduced into the container 50 from an introduction port or the like provided in the container 50. The container 50 can maintain the space inside the container 50 airtightly. The cathode member 10M and the anode member 40M are provided in the container 50. The anode member 40M is separated from the cathode member 10M.

As shown in FIG. 1A, the cathode member 10M has a cylindrical shape or an annular shape. The cathode member 10M includes a plurality of first cathode layers 10. The plurality of first cathode layers 10 are arranged along the plurality of sides of the polygon Q1. In this example, the polygon Q1 is a hexagon. Each of the plurality of first cathode layers 10 includes a first surface 10f. The first surface 10f faces the inside of the polygon Q1. The first surface 10f is planar.

A plane including the polygon Q1 is set to be an X-Y plane. A direction perpendicular to the X-Y plane is defined as a Z-axis direction. The first surface 10f is along the Z-axis direction. For example, a direction from the cathode member 10M to the anode member 40M is along the Z-axis direction.

For example, electrons are emitted from the first surface 10f of each of the plurality of first cathode layers 10.

When the plurality of first cathode layers 10 are crystalline, electrons are emitted with high efficiency. In a case where the first cathode layer 10 has a curved surface, it is practically difficult to obtain high crystallinity in the first cathode layer 10. When the first cathode layer 10 is planer, high crystallinity can be obtained in the first cathode layer 10. There by, electron emission can be obtained with high efficiency. As a result, high density plasma can be obtained. According to the embodiment, a plasma source capable of obtaining high-density plasma can be provided.

In the embodiment, it is preferable that the plurality of first cathode layers 10 include crystals. The plurality of first cathode layers 10 preferably include at least one selected from the group consisting of diamond, aluminum nitride, aluminum gallium nitride, gallium nitride, and C12A7 electrode. Thereby, emission of electrons with higher efficiency can be obtained. C12A7 includes 12CaO.7Al₂O₃.

As shown in FIG. 1A, the plurality of first cathode layers 10 include, for example, cathode layers 11a to 11f. Each of the cathode layers 11a to 11f has the first surface 10f being planar.

As shown in FIGS. 1A and 1B, in this example, the cathode member 10M further includes a plurality of first substrates 30. One of the plurality of first cathode layers 10 is supported by one of the plurality of first substrates 30. The one of the plurality of first cathode layers 10 is between another one of the plurality of first cathode layers 10 and the one of the plurality of first substrates 30. For example, the cathode layer 11a is located between the first substrate 30 that supports the cathode layer 11a and the cathode layer 11d.

The first cathode layer 10 is supported by the first substrate 30, so that the first cathode layer 10 is stabilized.

The plurality of first substrates 30 include, for example, at least one selected from the group consisting of molybdenum, tungsten, diamond, silicon, silicon carbide and gallium nitride. The plurality of first substrates 30 may be conductive. The plurality of first substrates 30 may include crystals. For example, the first cathode layers 10 may be formed on the first substrate 30 by crystal growth. For example, the first cathode layers 10 may be formed by epitaxial growth. The first cathode layers 10 with higher quality can be obtained. The first substrate 30 may be a single crystal substrate. When the first substrate 30 is a single crystal substrate, high crystallinity can be obtained in the first cathode layer 10. As a result, electron emission with high efficiency can be obtained. When the first substrate 30 is a single crystal substrate, the plane orientation of the crystal of the first cathode layer 10 can be controlled by the plane orientation of the substrate. For example, electron emission with high efficiency can be obtained.

As shown in FIG. 1B, the controller 70 may be provided. The controller 70 can apply a voltage between the cathode member 10M and the anode member 40M, for example.

As shown in FIGS. 1A and 1B, a magnetic field application part 60 may be provided. The plasma source 110 may include the magnetic field application part 60. The magnetic field application part 60 can apply a magnetic field MF to the space SP surrounded by the plurality of first cathode layers 10 (cathode member 10M). The magnetic field MF includes component in a direction (for example, the Z-axis direction) crossing the plane (X-Y plane) including the polygon Q1. For example, the magnetic field MF is along the Z-axis direction. The magnetic field application part 60 may be, for example, a magnet (for example, a permanent magnet). The magnetic field application part 60 may be, for example, an electromagnet.

With such a magnetic field MF, the cathode member 10M may function as a cross-field hollow cathode.

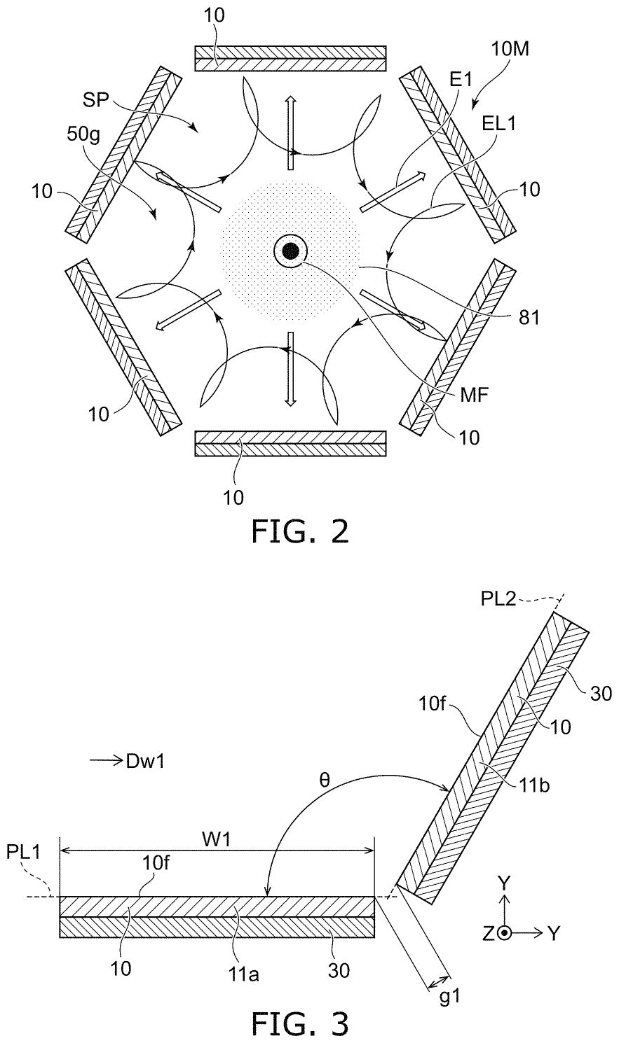

FIG. 2 is a schematic diagram illustrating an operation of the plasma source according to the first embodiment.

As shown in FIG. 2, the magnetic field MF is applied to the space SP surrounded by the cathode member 10M being cylindrical (or annular). The magnetic field MF is along the axial direction (Z-axis direction) of the cylinder. Negative glow 81 is formed in the center of the space SP. An electric field E1 is generated between the negative glow 81 and the cathode member 10M. The electrons EL1 drift while turning in the cylinder due to the magnetic field MF and the electric field E1. The electrons EL1 repeatedly collide with particles (molecules, etc.) of the gas 50g. Thereby ionization is promoted. As a result, a high-density plasma can be obtained.

In the embodiment, an angle of the apex angle of the polygons Q1 of the plurality of first cathode layers 10 preferably exceeds 90 degrees. Thereby, it is possible to suppress inhibition of the above-mentioned drift of the electrons EL1. The polygon Q1 may be, for example, a regular polygon.

FIG. 3 is a schematic cross-sectional view illustrating a part of the plasma source according to the first embodiment.

As shown in FIG. 3, one of the plurality of first cathode layers 10 (for example, the cathode layer 11a) is next to another one (for example, the cathode layer 11b) of the plurality of first cathode layers 10. An angle between the first surface 10f of the one (cathode layer 11a) of the first cathode layer 10 and the first surface 10f of the other one (cathode layer 11b) of the plurality of first cathode layers 10 is defined as an angle θ. In the embodiment, the angle θ preferably exceeds 90 degrees. The angle θ may be, for example, 120 degrees or more. The angle θ corresponds to the angle between the plane PL1 including the first surface 10f of the cathode layer 11a and the plane PL2 including the first surface 10f of the cathode layer 11b.

As shown in FIG. 3, the one (cathode layer 11a) of the plurality of first cathode layers 10 is separated from the other one (cathode layer 11b) of the plurality of first cathode layers 10. As a result, a stable cathode layer (and substrate) can be maintained even when the size of the cathode layer (and the substrate) changes due to thermal expansion or the like.

For example, a distance between one of the plurality of first cathode layers 10 (cathode layer 11a) and the other one of the plurality of first cathode layers 10 (cathode layer 11b) is defined as a distance g1. The width of one of the plurality of first cathode layers 10 (cathode layer 11a) is defined as the width W1. The width W1 is a width (length) along the first width direction Dw1 of the cathode layer 11a. The first width direction Dw1 is along the first surface 10f of the one (cathode layer 11a) of the plurality of first cathode layers 10. The first width direction Dw1 is along a plane (X-Y plane) including the polygon Q1. In this example, the first width direction Dw1 is along the X-axis direction. In the embodiment, the distance g1 is preferably, for example, not less than 0.001 times and not more than 0.1 times the width W1. By the distance g1 being not less than 0.001 times the width W1, it is easy to maintain a stable cathode layer (and substrate) even when the size of the cathode layer (and substrate) changes due to thermal expansion, for example. By the distance g1 being not more than 0.1 times the width W1, for example, adverse effects on the drift c of the electrons EL1 can be easily suppressed.

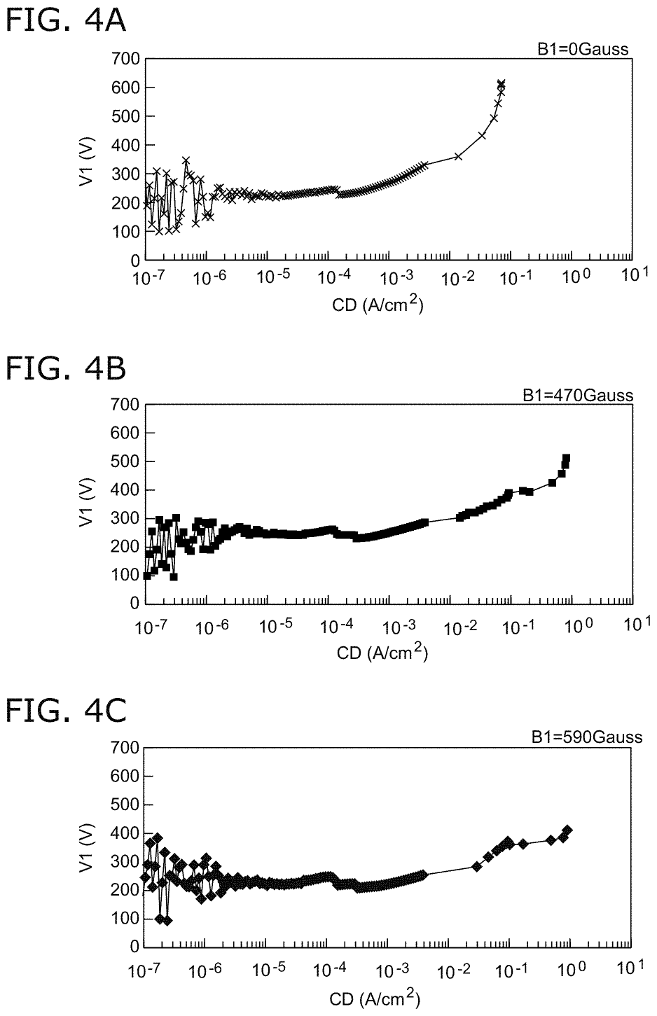

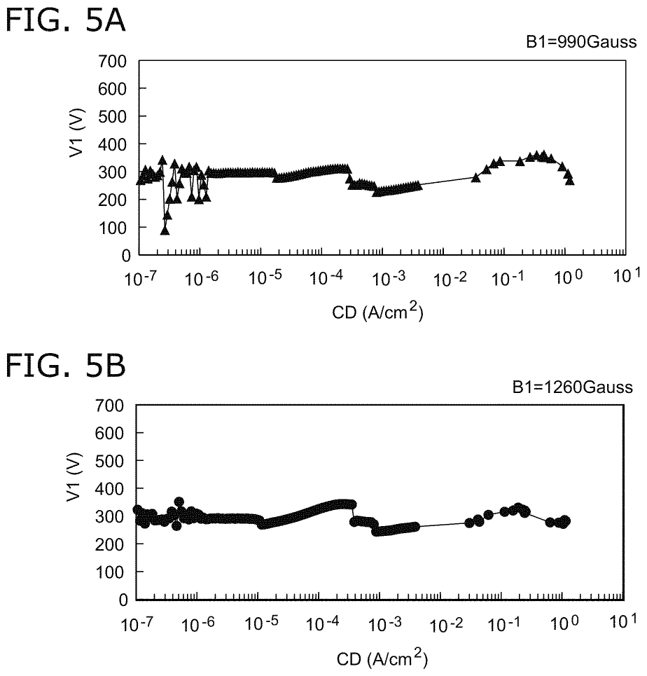

FIGS. 4A to 4C, 5A and 5B are graphs illustrating the characteristics of the plasma source according to the first embodiment.

The horizontal axis of these figures is the current density CD. The vertical axis is the voltage V1. The voltage V1 corresponds to the potential difference between the cathode member 10M and the anode member 40M. FIGS. 4A, 4B, 4C, 5A and 5B correspond the cases where the strength B1 of the magnetic field MF is 0 gausses, 470 gausses, 590 gausses, 990 gausses and 1260 gausses, respectively.

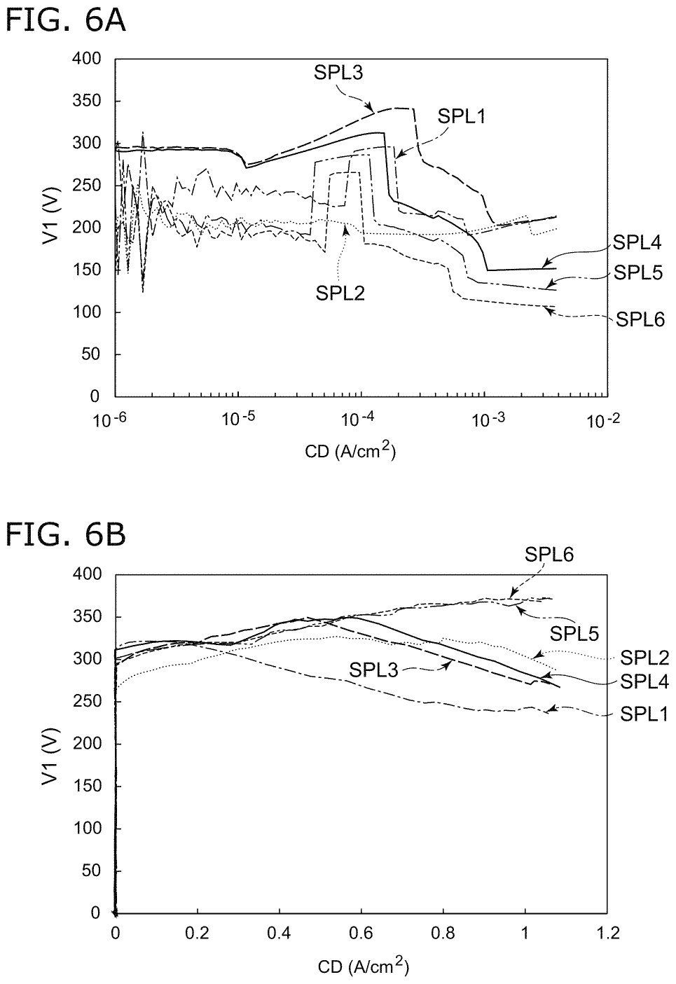

As shown in FIGS. 4A and 4B, when the strength B1 is 470 gausses, the voltage V1 is lower compared with that when the strength B1 is 0 gausses at the same current density CD. When the strength B1 is 470 gausses, a higher current density CD can be obtained at the same voltage V1 than that when the strength B1 is 0 gausses. This tendency becomes stronger as the strength B1 increases. For example, as shown in FIGS. 5A and 5B, when the strength B1 is 990 gausses or 1260 gausses, the voltage V1 is remarkably low at the same current density CD. FIGS. 6A and 6B are graphs illustrating the characteristics of the plasma source according to the first embodiment.

The horizontal axis of these figures is the current density CD. The vertical axis is the voltage V1. FIG. 6A shows the characteristics in the high current density region. FIG. 6B shows the characteristics in the low current density region. In these figures, the characteristics of the first to sixth samples SPL1 to SPL6 are illustrated. In the first sample SPL1, the material of the plurality of first cathode layers 10 is molybdenum. In the second sample SPL2, the material of the plurality of first cathode layers 10 is amorphous carbon (a-C). In the third sample SPL3, the material of the plurality of first cathode layers 10 is diamond-like carbon (DLC). In the fourth sample SPL4, the material of the plurality of first cathode layers 10 is diamond (p-type diamond). In the fifth sample SPL5, the material of the plurality of first cathode layers 10 is high quality diamond (p-type diamond). In the sixth sample SPL6, the material of the plurality of first cathode layers 10 is high quality diamond (p-type diamond).

As shown in FIG. 6A, the voltage V1 of the fourth to sixth samples SPL4 to SPL6 is lower than that of the first to third samples SPL1 to SPL3 when the current density CD is the same. That is, in the fourth to sixth samples SPL4 to SPL6, the same current density CD can be obtained with lower power consumption than the first to third samples SPL1 to SPL3. The material of the plurality of first cathode layers 10 is preferably diamond (p-type diamond). A lower voltage V1 is obtained in the fifth sample SPL5 and sixth sample SPL6 being of high quality. It is more preferable that the material of the plurality of first cathode layers 10 is high quality diamond (p-type diamond).

As shown in FIG. 6B, in the first to fourth samples SPL1 to SPL4, the voltage V1 is low in the region where the current density CD is not less than 0.8 A/cm² and not more than 1.2 A/cm². In the fifth sample SPL5 and the sixth sample SPL6, the voltage V1 is high in the region where the current density CD is not less than 0.8 A/cm² and not more than 1.2 A/cm². In the first to fourth samples SPL1 to SPL4, the transition to arc discharge is likely to occur. In this case, for example, negative resistance occurs. On the other hand, in the fifth sample SPL5 and the sixth sample SPL6, the transition to the arc discharge is suppressed. It is more preferable that the material of the plurality of first cathode layers 10 is high quality diamond (p-type diamond).

In the fourth sample SPL4, the concentration of B (boron) included in the diamond (p-type diamond) is about 2×10²¹/cm³, the concentration of H (hydrogen) is about 1×10²²/cm³, and the concentration of N (nitrogen) is about 1×10¹⁹/cm³, and the concentration of P (phosphorus) is not more than 1×10¹⁶/cm³.

In the fifth sample SPL5, the concentration of B (boron) included in the diamond (p-type diamond) is about 3×10²¹/cm³, the concentration of H (hydrogen) is not more than about 5×10²⁰/cm³, and the concentration of N (nitrogen) is about 5×10¹⁸/cm³, and the concentration of P (phosphorus) is not more than 1×10¹⁶/cm³.

In the sixth sample SPL6, the concentration of B (boron) included in the diamond (p-type diamond) is about 7×10²⁰/cm³, the concentration of H (hydrogen) is not more than about 2×10²¹/cm³, and the concentration of N (nitrogen) is about 4×10¹⁸/cm³, and the concentration of P (phosphorus) is not more than 1×10¹⁶/cm³.

As described above, the concentration of hydrogen included in the diamond of the fifth sample SPL5 and the sixth sample SPL6 is lower than the concentration of hydrogen included in the diamond of the fourth sample SPL4. It is considered that such a difference in concentration is related to the difference in characteristics described with respect to FIG. 6B.

In the embodiment, when the plurality of first cathode layers 10 include diamond, the concentration of hydrogen included in the diamond is preferably not more than 5×10²¹/cm³, for example. The concentration of hydrogen included in the diamond may be, for example, not more than 1×10¹⁹/cm³.

In the embodiment, when the plurality of first cathode layers 10 include diamond, the concentration of B (boron) included in the diamond is preferably not less than 1×10²⁰/cm³ and not more than 8×10²¹/cm³, for example.

In the embodiment, when the plurality of first cathode layers 10 include diamond, the concentration of P (phosphorus) included in the diamond is preferably less than 1×10¹⁶/cm³, for example. The concentration of P (phosphorus) included in the diamond may be, for example, not less than 1×10¹⁴/cm³.

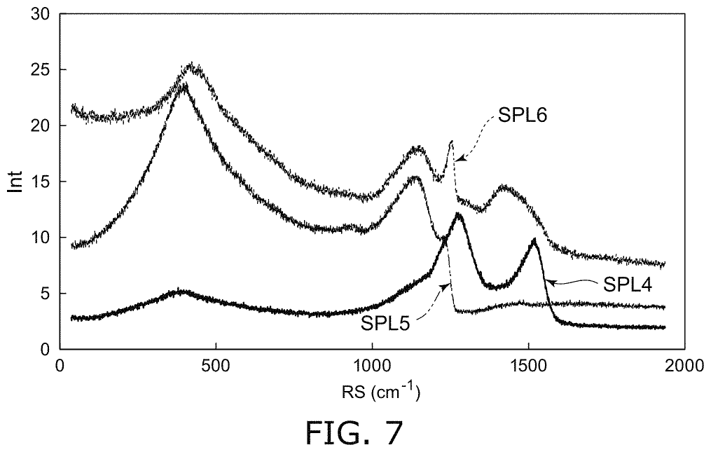

FIG. 7 is a graph illustrating the characteristics of the plasma source according to the first embodiment.

FIG. 7 illustrates the measurement results of the Raman spectrum for the fourth to sixth samples SPL4 to SPL6. The horizontal axis of FIG. 7 is Raman shift Rs. The vertical axis is the signal intensity Int (relative value). These figures show the results of the fourth to sixth samples SPL4 to SPL6.

In FIG. 7, the Raman shift Rs of about 440 cm⁻¹ and the Raman shift Rs of about 1205 cm⁻¹ correspond to B-doped diamonds. Raman shift Rs of about 1305 cm⁻¹ correspond to intrinsic diamonds. The Raman shift Rs of about 1350 cm⁻¹ corresponds to disturbed spa-bonded carbon. The Raman shift Rs of about 1570 cm⁻¹ correspond to sp²-bound carbon.

As shown in FIG. 7, in the Raman spectrum of the fourth sample SPL4, the intensity Int at Raman shift Rs of about 1350 cm⁻¹ and the intensity Int of Raman shift Rs at about 1570 cm⁻¹ are high. This indicates that the proportion of sp²-bound carbon is high in the fourth sample SPL4. In the fifth sample SPL5 and the sixth sample SPL6, their intensities Int are low. This indicates that the proportion of spa-bonded carbon is high in the fifth sample SPL5 and the sixth sample SPL6.

In the embodiment, in the Raman spectrum of the plurality of first cathode layers 10, it is preferably that the intensity Int at the Raman shift Rs of 440 cm⁻¹ is higher than the intensity Int at the Raman shift Rs of 1350 cm⁻¹ and higher than the intensity Int at the Raman shift Rs of 1570 cm⁻¹. In the plurality of first cathode layers 10, it is preferable that the intensity Int at the Raman shift Rs of 1205 cm⁻¹ is higher than the intensity Int at the Raman shift Rs of 1350 cm⁻¹ and higher than the intensity Int at the Raman shift Rs of 1570 cm⁻¹. By such characteristics, for example, power consumption during discharging can be reduced. For example, glow discharge can be maintained up to high current densities. For example, the transition to arc discharge can be effectively suppressed.

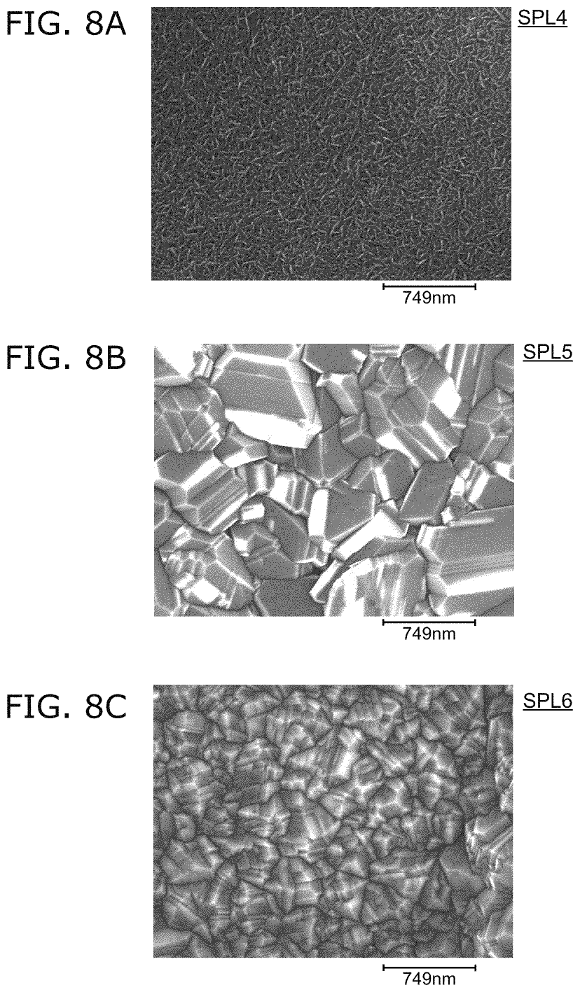

FIGS. 8A to 8C are electron micrographs illustrating a part of the plasma source according to the first embodiment.

These figures show examples of electron micrographs of diamonds (p-type diamonds) in a plurality of first cathode layers 10. FIGS. 8A to 8C correspond to the fourth to sixth samples SPL4 to SPL6, respectively.

As shown in FIG. 8A, fine particles are observed in the fourth sample SPL4. As shown in FIGS. 8B and 8C, large particles having clear crystal morphology are observed in the fifth sample SPL5 and the sixth sample SPL6.

In the embodiment, an average diameter of the plurality of particles included in the plurality of first cathode layers 10 is preferably not less than 50 nm. Thereby, for example, the transition to the arc discharge can be effectively suppressed. The average diameter of the plurality of particles may be, for example, not more than 5000 nm.

As already explained, the hydrogen concentration is high in the fourth sample SPL4. It is considered that this is because hydrogen is distributed locally in the region between a plurality of fine particles in the fourth sample SPL4.

A product of the distance dl between two of the first cathode layers 10 (see FIG. 1A) opposing to each other and the pressure of the gas 50g is preferably not less than 1 Pa m and not more than 10 Pa m.

The distance between two of the plurality of first cathode layers 10 opposing to each other is preferably not less than 5 mm and not more than 30 mm.

The gas pressure is preferably not less than 1 Pa and not more than 3000, for example. When the gas pressure is less than 1 Pa, for example, the distance dl is 1 m or more in order to form the negative glow 81 in the space SP. Therefore, the size of the device becomes large. On the other hand, when the gas pressure exceeds 3000 Pa, number of times of the collision between the electrons and the gas increases, and the temperature of the gas tends to rise. Therefore, the transition to the arc discharge is likely to occur.

Hereinafter, examples of the shape of the polygon Q1 corresponding to the plurality of first cathode layers 10 included in the cathode member 10M will be described.

It is assumed as that the planar shape of the negative glow 81 (see FIG. 2) is circular. The negative glow 81 enters the hollow cathode, then the hollow cathode effect can be obtained. The negative glow 81 is confined by the cathode member 10M having the shape of the polygon Q1 corresponding to the plurality of first cathode layers 10. In this case, the smallest polygon Q1 in which the negative glow 81 is confined circumscribes the circle of the negative glow 81.

The density of charged particles inside the negative glow 81 cannot be changed at a distance less than the Debye length in the plasma forming the negative glow 81. In other words, the density of charged particles can vary over distances greater than or equal to the Debye length. Therefore, the circular radius of the negative glow 81 is equal to or greater than the Debye length. The negative glow 81 can be efficiently confined by the cathode member 10M having the polygon Q1 circumscribing the circular negative glow 81 having a radius equal to or larger than the Debye length.

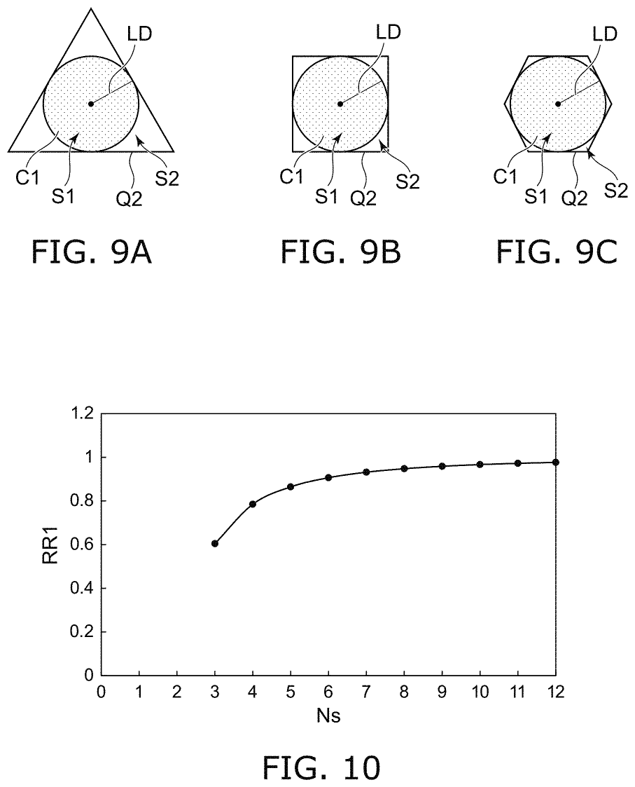

FIGS. 9A to 9C are schematic views illustrating a part of the plasma source according to the first embodiment.

These figures exemplify the shape of the polygon Q2 corresponding to the plurality of first cathode layers 10 included in the cathode member 10M. In this example, the polygon Q2 is a regular polygon. FIG. 9A corresponds to the case where the number Ns of the vertices of the polygon Q2 is 3. FIG. 9B corresponds to the case where the number Ns of the vertices of the polygon Q2 is 4. FIG. 9A corresponds to the case where the number Ns of the vertices of the polygon Q2 is 6. As shown in these figures, the polygon Q2 is a polygon circumscribing the circle C1 of the circular negative glow 81. Let the radius of the circle C1 be the length LD. The length LD corresponds to the Debye length. Let the area of the circle C1 be an area S1. Let the area of the polygon Q2 be an area S2.

FIG. 10 is a graph illustrating the characteristics of the plasma source according to the first embodiment.

The horizontal axis of FIG. 10 is the number Ns of the vertices of the polygon Q2. The number Ns corresponds to the number of sides of the polygon Q2. The vertical axis of FIG. 10 is a ratio RR1. The ratio RR1 is the ratio (S1/S2) of the area S1 of the circle C1 to the area S2 of the polygon Q2. The higher the ratio RR1 and the closer the ratio RR1 to 1, the smaller the plasma source can be.

As shown in FIG. 10, as the number Ns of the vertices of the polygon Q2 increases, the ratio RR1 increases. When the number Ns is 3, the ratio RR1 is low. The ratio RR1 when the number Ns is 4 is considerably higher than the ratio RR1 when the number Ns is 3. When the number Ns is 5 or less, the ratio RR1 is lower than 0.9. When the number Ns of the vertices of the polygon Q2 is 6 or more, the ratio RR1 is 0.9 or more. When the number Ns of the vertices of the polygon Q2 is 6 or more, the change of the ratio RR1 with respect to the increase of the number Ns becomes small.

In the embodiment, the number Ns is preferably 4 or more. High efficiency can be obtained and the size can be reduced. The number Ns is more preferably 6 or more. The size can be made smaller.

When the number Ns becomes excessively large, the size of each of the plurality of first cathode layers 10 becomes small with respect to the total size of the cathode member 10M. For example, the influence of loss due to the distance g1 (see FIG. 3) between the plurality of first cathode layers 10 becomes large. Therefore, the number Ns is preferably 12 or less.

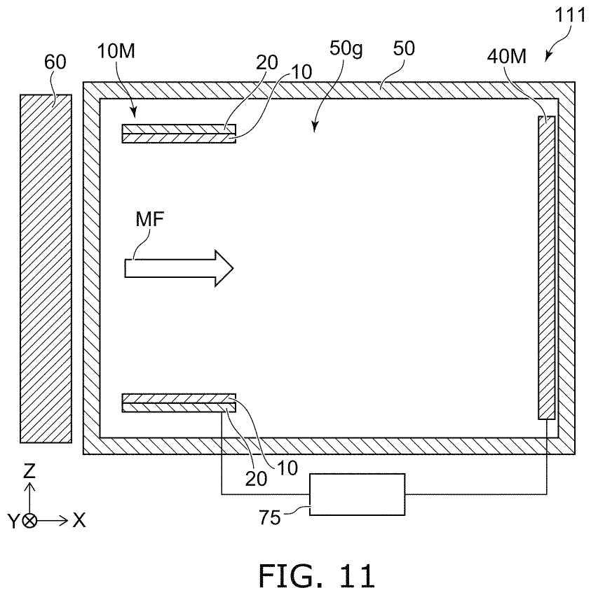

FIG. 11 is a schematic cross-sectional view illustrating a plasma source according to the first embodiment.

As shown in FIG. 11, in a plasma source 111 according to the embodiment, the magnetic field application part 60 does not overlap the cathode member 10M is in the X-Y plane. For example, in the Z-axis direction, the cathode member 10M may be between the container 50 and the anode member 40M. At least a part of the magnetic field application part 60 may not overlap the container 50 in the X-Y plane.

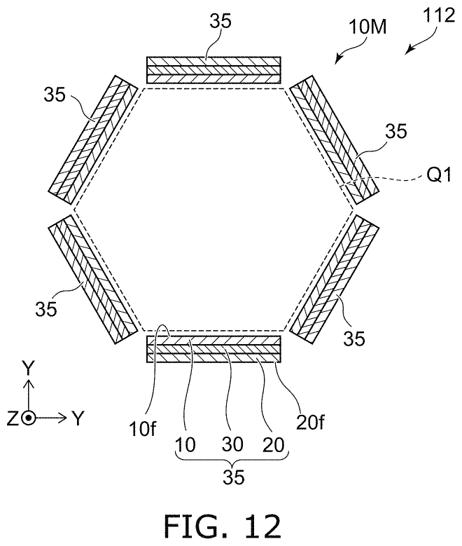

FIG. 12 is a schematic cross-sectional view illustrating a part of the plasma source according to the first embodiment.

As shown in FIG. 12, in a plasma source 112 according to the embodiment, the cathode member 10M further includes a plurality of second cathode layers 20 and a plurality of first substrates 30. One of the plurality of first substrates 30 is located between one of the plurality of first cathode layers 10 and one of the plurality of second cathode layers 20. For example, the first cathode layer 10 is provided on a surface of one of the first substrates 30, and the second cathode layer 20 is provided on another surface of the one of the first substrates 30. One of the first cathode layers 10, one of the first substrates 30, and one of the second cathode layers 20 are included in one stacked body 35.

Each of the plurality of second cathode layers 20 includes a second surface 20f. The second surface 20f faces the outside of the polygon Q1 and is plane.

In the plasma source 111, electrons EL1 are emitted from the first cathode layer 10. In addition, electrons EL1 can also be emitted from the second cathode layer 20. Higher efficiency emissions are obtained.

A plurality of such cathode members 10M may be provided. For example, the plurality of cathode members 10M may be provided along a plane (X-Y plane) including the polygon Q1.

In the plasma source 112, the first cathode layer 10 and the second cathode layer 20 preferably include crystals. The first cathode layer 10 and the second cathode layer 20 preferably include at least one selected from the group consisting of diamond, aluminum nitride, aluminum gallium nitride, gallium nitride, and C12A7 electride. The first substrate 30 preferably includes, for example, a crystal (for example, a single crystal).

### Second Embodiment

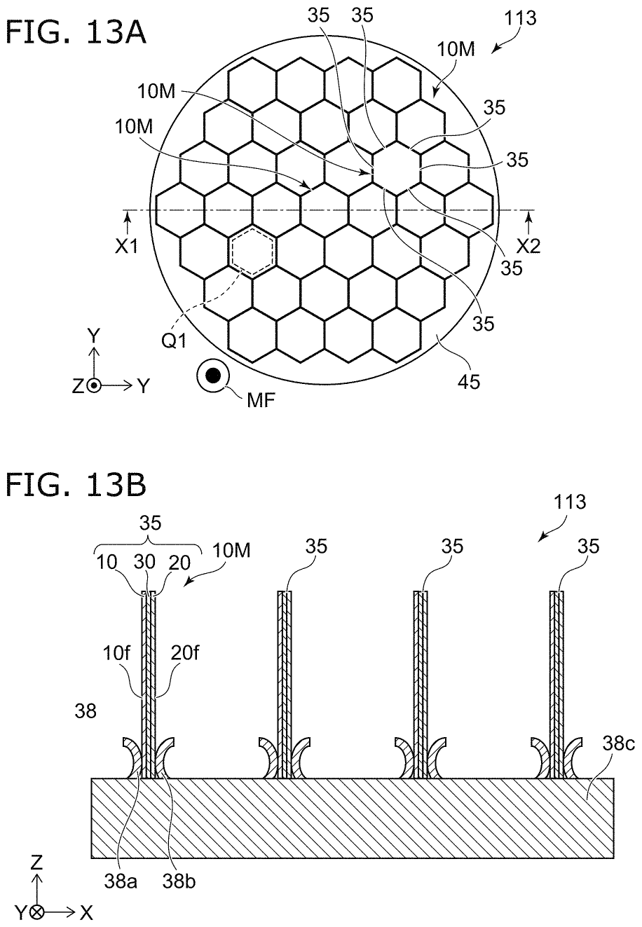

FIGS. 13A and 13B are schematic cross-sectional views illustrating a part of a plasma source according to a second embodiment.

These figures illustrate the cathode member 10M in a plasma source 113 according to the embodiment. The configuration of the plasma source 113 excluding the cathode member 10M may be the same as the configuration of the plasma source 110 or 111. The configuration described with respect to the plasma source 112 is applied to the cathode member 10M in the plasma source 113.

FIG. 13B is a cross-sectional view taken along the line X1-X2 of FIG. 13A. As shown in FIG. 13A, a plurality of cathode members 10M are provided in the plasma source 113. The plurality of cathode members 10M are provided along a plane (X-Y plane) including the polygon Q1.

Alternatively, in the plasma source 113, the entire plurality of cathode members 10M may be regarded as one cathode member. In this case, for example, the cathode member 10M is considered to include the plurality of stacked bodies 35. Each of the plurality of stacked bodies 35 includes a first cathode layer 10, a second cathode layer 20, and a first substrate 30 (see FIG. 12). As described above, the first substrate 30 is provided between the first cathode layer 10 and the second cathode layer 20. The first surface 10f of the first cathode layer 10 and the second surface 20f of the second cathode layer 20 are planar.

As shown in FIG. 13A, the plurality of stacked bodies 35 are arranged along the plurality of sides of the polygon Q1. A plurality of groups including such a plurality of stacked bodies 35 are arranged along the X-Y plane.

In the plasma source 113, the magnetic field MF is applied to each of the plurality of groups. Emission of electrons from both the first cathode layer 10 and the second cathode layer 20 is used. Higher plasma density is obtained.

As shown in FIG. 13B, the plasma source 113 may include a support portion 38. The support portion 38 supports the plurality of cathode members 10M. The support portion 38 supports, for example, the plurality of stacked bodies 35. For example, the support portion 38 includes a first support member 38a and a second support member 38b. One of the plurality of cathode members 10M is provided between the first support member 38a and the second support member 38b. For example, one of the plurality of stacked bodies 35 is provided between the first support member 38a and the second support member 38b. For example, one of the plurality of first substrates 30 is provided between the first support member 38a and the second support member 38b.

The support portion 38 may include a third support member 38c. The third support member 38c supports the first support member 38a and the second support member 38b. The third support member 38c is a base. The first support member 38a and the second support member 38b are, for example, elastic members.

In the plasma sources 112 and 113, the number of a plurality of corners of the polygon Q1 is preferably 4 or more. For example, the polygon Q1 is preferably a hexagon. A dense structure is obtained.

### Third Embodiment

The third embodiment relates to a switch device.

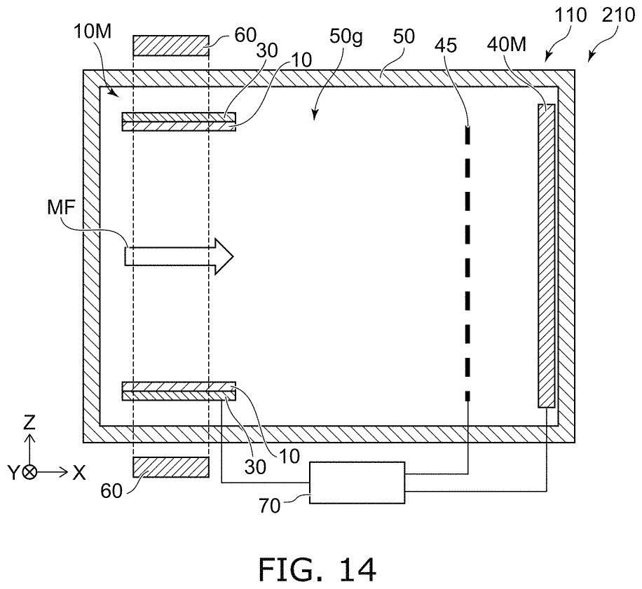

FIG. 14 is a schematic cross-sectional view illustrating a switch device according to a third embodiment.

As shown in FIG. 14, a switch device 210 according to the embodiment includes the plasma source (plasma source 110 in this example) according to the first embodiment or the second embodiment, and a control conductive part 45. The control conductive part 45 is provided in the container 50. The control conductive part 45 is connected with, for example, a controller 70. The potential of the control conductive part 45 is controlled by the controller 70. Thereby, the current flowing between the cathode member 10M and the anode member 40M can be controlled.

The embodiments may include the following configurations (for example, technical proposals).

### Configuration 1

A plasma source, comprising:

a container being configured to store a gas;

a cathode member provided in the container, the cathode member including a plurality of first cathode layers, each the cathode layers being arranged along a plurality of sides of a polygon, each of the first cathode layers including a first surface facing inside the polygon, the first surface being planar; and

an anode member provided in the container.

### Configuration 2

The plasma source according to configuration 1, wherein the first cathode layers include crystal.

### Configuration 3

The plasma source according to configuration 1 or 2, wherein the first cathode layers include at least one selected from the group consisting of diamond, aluminum nitride, aluminum gallium nitride, gallium nitride, and C12A7 electride.

### Configuration 4

The plasma source according to configuration 1 or 2, wherein

at least one of the first cathode layers includes diamond, and

a concentration of hydrogen included in the diamond is not more than 5×10²¹/cm³.

### Configuration 5

The plasma source according to configuration 1 or 2, wherein

at least one of the first cathode layers includes diamond, and

in a Raman spectrum of the first cathode layers, an intensity at a Raman shift of 440 cm⁻¹ is higher than an intensity at a Raman shift of 1350 cm⁻¹ and higher than an intensity at a Raman shift of 1570 cm⁻¹.

### Configuration 6

The plasma source according to configuration 1 or 2, wherein

at least one of the first cathode layers includes diamond, and

in a Raman spectrum of the first cathode layers, an intensity at a Raman shift of 1205 cm⁻¹ is higher than an intensity at a Raman shift of 1350 cm⁻¹ and higher than an intensity at a Raman shift of 1570 cm⁻¹.

### Configuration 7

The plasma source according to configuration 1 or 2, wherein an average diameter of a plurality of particles included in at least one of the first cathode layers is 50 nm or more.

### Configuration 8

The plasma source according to any of one of configurations 1 to 7, wherein

the cathode member further includes a plurality of first substrates,

one of the first cathode layers is supported by one of the first substrates, and

the one of the cathode layers is located between an other one of the first cathode layers and the one of the first substrates.

### Configuration 9

The plasma source according to configuration 8, wherein the first substrates include crystal.

### Configuration 10

The plasma source according to any of one of configurations 1 to 9, wherein

one of the first cathode layers is next to an other one of the first cathode layers, and

an angle between the first surface of the one of the first cathode layer and the first surface of the other one of the first cathode layers exceeds 90 degrees.

### Configuration 11

The plasma source according to any of one of configurations 1 to 9, wherein

one of the first cathode layers is next to an other one of the first cathode layers,

the one of the first cathode layers is separated from the other one of the first cathode layers,

a distance between the one of the first cathode layers and the other one of the first cathode layers is not less than 0.001 times and not more than 0.1 times a width along a first width direction of the one of the first cathode layers, and

the first width direction is along the first surface of the one of the first cathode layers and along a plane including the polygon.

### Configuration 12

The plasma source according to any of one of configurations 1 to 7, wherein

the cathode member further includes
a plurality of second cathode layers, and
a plurality of first substrates,

one of the first substrates is located between one of the first cathode layers and one of the second cathode layers,

each of the second cathode layers includes a second surface facing outside of the polygon, and

the second surface is planar.

### Configuration 13

The plasma source according to configuration 12, wherein

a plurality of the cathode members are provided, and

the cathode members are provided along a plane including the polygon.

### Configuration 14

The plasma source according to configuration 13, further comprising a support portion supporting the cathode members.

### Configuration 15

The plasma source according to configuration 14, wherein

the support portion includes a first support member and a second support member, and

one of the first substrates is located between the first support member and the second support member.

### Configuration 16

A plasma source, comprising:

a container configured to store a gas;

a cathode member provided in the container, the cathode member including a plurality of stacked bodies, each of the stacked bodies including a first cathode layer, a second cathode layer, and a first substrate provided between the first cathode layer and the second cathode layer, the stacked bodies being arranged along a plurality of sides of the polygon, a first surface of the first cathode layer and a second surface of the second cathode layer being planar; and

an anode member provided in the container.

### Configuration 17

The plasma source according to configuration 16, wherein the first cathode layer and the second cathode layer include at least one selected from the group consisting of diamond, aluminum nitride, aluminum gallium nitride, gallium nitride, and C12A7 electride.

### Configuration 18

The plasma source according to any one of configurations 1 to 17, further comprising a magnetic field application part configured to apply a magnetic field to a space surrounded by the first cathode layers.

### Configuration 19

The plasma source according to configuration 18, wherein a magnetic field in a space surrounded by the first cathode layers is not less than 100 gausses and not more than 3000 gausses.

### Configuration 20

The plasma source according to configuration 18 or 19, wherein a direction from the cathode member to the anode member crosses a plane including the polygon.

### Configuration 21

The plasma source according to any one of configurations 1 to 20, wherein a product of a distance between two of the first cathode layers opposing to each other and a pressure of the gas is not less than 1 Pa m and not more than 10 Pa m.

### Configuration 22

The plasma source according to any one of configurations 1 to 21, wherein a distance between two of the first cathode layers opposing each other not less than is 5 mm and not more than 30 mm.

### Configuration 23

The plasma source according to any one of configurations 1 to 20, wherein a pressure of the gas is not less than 1 Pa and not more than 1000 Pa.

### Configuration 24

A switch device, comprising:

the plasma source according to any one of configurations 1 to 23; and

a control conductive part provided in the container.

According to the embodiment, a plasma source and a switch device capable of obtaining high-density plasma can be provided.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in semiconductor devices such as cathode members, cathode layers, anode member, containers, magnetic field application parts, controller, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all plasma sources and all switch devices practicable by an appropriate design modification by one skilled in the art based on the plasma sources and the switch devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A plasma source, comprising:
a container being configured to store a gas;
a cathode member provided in the container, the cathode member including a plurality of first cathode layers, each the cathode layers being arranged along a plurality of sides of a polygon, each of the first cathode layers including a first surface facing inside the polygon, the first surface being planar; and
an anode member provided in the container.

2. The source according to claim 1, wherein the first cathode layers include crystal.

3. The source according to claim 1, wherein the first cathode layers include at least one selected from the group consisting of diamond, aluminum nitride, aluminum gallium nitride, gallium nitride, and C12A7 electride.

4. The source according to claim 1, wherein
at least one of the first cathode layers includes diamond, and
a concentration of hydrogen included in the diamond is not more than 5×10²¹/cm³.

5. The source according to claim 1, wherein
at least one of the first cathode layers includes diamond, and
in a Raman spectrum of the first cathode layers, an intensity at a Raman shift of 440 cm⁻¹ is higher than an intensity at a Raman shift of 1350 cm⁻¹ and higher than an intensity at a Raman shift of 1570 cm⁻¹.

6. The source according to claim 1, wherein
at least one of the first cathode layers includes diamond, and
in a Raman spectrum of the first cathode layers, an intensity at a Raman shift of 1205 cm⁻¹ is higher than an intensity at a Raman shift of 1350 cm⁻¹ and higher than an intensity at a Raman shift of 1570 cm⁻¹.

7. The source according to claim 1, wherein an average diameter of a plurality of particles included in at least one of the first cathode layers is 50 nm or more.

8. The source according to claim 1, wherein
the cathode member further includes a plurality of first substrates,
one of the first cathode layers is supported by one of the first substrates, and
the one of the cathode layers is located between an other one of the first cathode layers and the one of the first substrates.

9. The source according to claim 8, wherein the first substrates include crystal.

10. The source according to claim 1, wherein
one of the first cathode layers is next to an other one of the first cathode layers, and
an angle between the first surface of the one of the first cathode layer and the first surface of the other one of the first cathode layers exceeds 90 degrees.

11. The source according to claim 1, wherein
one of the first cathode layers is next to an other one of the first cathode layers,
the one of the first cathode layers is separated from the other one of the first cathode layers,
a distance between the one of the first cathode layers and the other one of the first cathode layers is not less than 0.001 times and not more than 0.1 times a width along a first width direction of the one of the first cathode layers, and
the first width direction is along the first surface of the one of the first cathode layers and along a plane including the polygon.

12. The source according to claim 1, wherein
the cathode member further includes
a plurality of second cathode layers, and
a plurality of first substrates,
one of the first substrates is located between one of the first cathode layers and one of the second cathode layers,
each of the second cathode layers includes a second surface facing outside of the polygon, and
the second surface is planar.

13. The source according to claim 12, wherein
a plurality of the cathode members are provided, and
the cathode members are provided along a plane including the polygon.

14. The source according to claim 13, further comprising a support portion supporting the cathode members.

15. The source according to claim 14, wherein
the support portion includes a first support member and a second support member, and
one of the first substrates is located between the first support member and the second support member.

16. A plasma source, comprising:
a container configured to store a gas;
a cathode member provided in the container, the cathode member including a plurality of stacked bodies, each of the stacked bodies including a first cathode layer, a second cathode layer, and a first substrate provided between the first cathode layer and the second cathode layer, the stacked bodies being arranged along a plurality of sides of the polygon, a first surface of the first cathode layer and a second surface of the second cathode layer being planar; and
an anode member provided in the container.

17. The source according to claim 16, wherein the first cathode layer and the second cathode layer include at least one selected from the group consisting of diamond, aluminum nitride, aluminum gallium nitride, gallium nitride, and C12A7 electride.

18. The source according to claim 1, further comprising a magnetic field application part configured to apply a magnetic field to a space surrounded by the first cathode layers.

19. The source according to claim 18, wherein a direction from the cathode member to the anode member crosses a plane including the polygon.

20. A switch device, comprising:
the plasma source according to claim 1; and
a control conductive part provided in the container.
